(19) United States
(12) Patent Application Publication
(10) Pub. No.: US 2021/0021440 A1
(43) Pub. Date: Jan. 21, 2021

(54) PRESENTER SERVER FOR BROKERING PRESENTER CLIENTS

(71) Applicant: VMware, Inc., Palo Alto, CA (US)

(72) Inventor: Erich Peter Stuntebeck, Johns Creek, GA (US)

(21) Appl. No.: 16/511,883

(22) Filed: Jul. 15, 2019

(51) Int. Cl. H04L 12/18; H04L 29/08; G06F 9/451

(52) U.S. Cl. CPC H04L 12/1827; H04L 12/1818; G06F 9/452; H04L 67/2809

(57) ABSTRACT

Disclosed are aspects of a presenter server application that can broker requests to present contents of presenter client applications. The presenter client applications can join a presenter session and make requests to display content on a display device coupled to the presenter server device.

### BACKGROUND

In collaborative or creative work environments, a process for generating ideas often involves group sessions. Groups often form smaller breakout groups to generate new ideas or work on solving problems together. It is common for participants to use large physical sheets of paper on an easel or a whiteboard for group breakout sessions, and then these sheets are often shared with the rest of the group meeting for discussion. In a situation where various breakout groups generate content to share with the larger group, sharing and presenting the contents of a large sheet of paper or a whiteboard can be cumbersome and clunky.

In the case of a large sheet of paper on an easel, some solutions to make sharing its contents easier are taking a picture of the sheet and presenting in using a projection system. However, the group is then unable to further mark up or make changes to the sheet that are also disseminated to the group or easily receive markup and feedback on the sheet from the larger group. Additionally, in the case of a meeting involving many breakout groups, there might be many sheets that need to be shared with the larger group. Moderating a group involving multiple submissions of physical sheets of paper can also be a cumbersome task that can seem outdated in an increasingly digital society.

Additionally, creating and disseminating sheets of paper with potentially sensitive and confidential information that can be directed to valuable new ideas of an enterprise can be an inefficient and ineffective information security practice.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a block diagram illustrating an example of a networked environment according to examples of the disclosure.

FIG. 2 is an example scenario according to embodiments of the disclosure.

FIG. 3 is an example scenario according to embodiments of the disclosure.

FIG. 4 is a flowchart that illustrates an example of functionalities performed by embodiments of the disclosure.

FIG. 5 is a flowchart that illustrates an example of functionalities performed by embodiments of the disclosure.

### DETAILED DESCRIPTION

Disclosed are examples of systems and methods for facilitating information sharing in a collaborative environment. In office environments, a common scenario involves a larger group of people coming together to brainstorm, innovate, or solve problems. Additionally, smaller breakout groups can form where smaller teams collaborate on innovation or problem solving. Oftentimes, smaller breakout groups can reconvene into a larger group, where the ideas, solutions, or problems discussed in smaller breakout groups are presented to the larger group. One way this process can evolve is by the breakout groups creating content on large rolls or pieces of paper or on a whiteboard. Sometimes, a digital whiteboard device is used where the contents of the whiteboard can be saved or printed out on a roll of paper.

When these breakout groups reconvene into a larger group, it can be a cumbersome process to present when the groups created to the larger group. Again, if the content the breakout groups created is on paper or a whiteboard, presenting that information in a format that can be easily presented and viewed by the larger group can be difficult. Additionally, brokering what gets presented and when can also be cumbersome. A moderator of the larger group might be tasked with deciding who presents and in what order as well as with saving the materials that are presented. The contents that are presented might involve further discussion in the larger group, where markup, feedback, or comments from the larger group are obtained. Preserving the feedback markup along with the originally presented materials can be a difficult and cumbersome task for the moderator.

Therefore, examples of the disclosure can streamline this process by introducing a presenter server device 105 that is attached to a display. The presenter server device 105 can broker content from multiple presenter client devices 106 and present one or more of the contents provided by the presenter client devices 106 onto a display device 107. Additionally, the presenter server device 105 can allow the presenter to enter markup, edit the contents, or provide comments, which can saved or archived along with the contents provided by the corresponding presenter managed device.

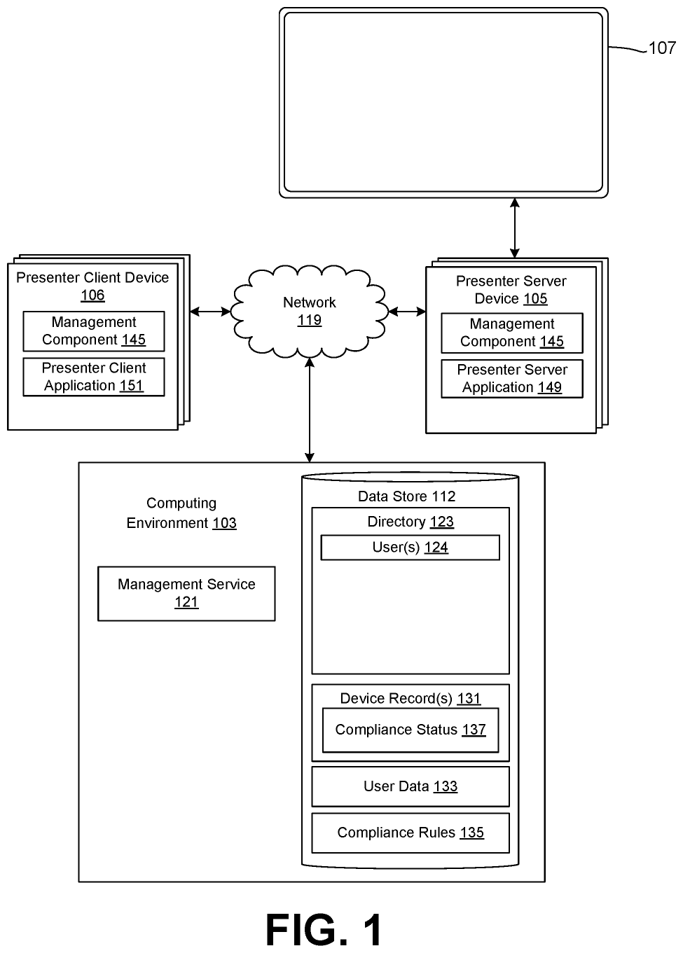

FIG. 1 illustrates an example of a networked environment 100 according to examples of the disclosure. In the depicted network environment 100, a presenter server device 105, at least one presenter managed device, a display device 107, and a computing environment 103 are in communication with at least one managed device over a network 119.

The network 119 includes the Internet, intranets, extranets, wide area networks (WANs), local area networks (LANs), wired networks, wireless networks, other suitable networks, or any combination of two or more such networks. The networks can include satellite networks, cable networks, Ethernet networks, and other types of networks.

The computing environment 103 can be one that is operated by an enterprise, such as a business or other organization. The computing environment 103 includes a computing device, such as a server computer, that provides computing capabilities. Alternatively, the computing environment 103 can employ multiple computing devices that are arranged in one or more server banks or computer banks. In one example, the computing devices can be located in a single installation. In another example, the computing devices for the computing environment 103 can be distributed among multiple different geographical locations. In one case, the computing environment 103 include multiple computing devices that together can form a hosted computing resource or a grid computing resource. Additionally, the computing environment 103 can operate as an elastic computing resource where the allotted capacity of computing-related resources, such as processing resources, network resources, and storage resources, can vary over time. In other examples, the computing environment 103 can include or be operated as one or more virtualized computer instances that can be executed to perform the functionality that is described herein.

Various applications or other functionality can be executed in the computing environment 103. Also, various data can be stored in a data store 112 that can be accessible to the computing environment 103. The data store 112 can be representative of a plurality of data stores 112. The data stored in the data store 112 can be associated with the operation of the various applications or functional entities described below.

The components executed on the computing environment 103 can include a management service 121 and other applications, services, processes, systems, engines, or functionality not discussed in detail herein. In some implementations, devices associated with users in a corporate environment can be managed devices that are enrolled with a management service 121. The management service 121 can be executed by the computing environment 103 in an on-premise implementation or in another computing environment that is separate from the computing environment 103.

The management service 121 can monitor and oversee the operation of one or more client devices, such as presenter server devices 105 or presenter client devices 106, by administrators. In some examples, the management service 121 can represent one or more processes or applications executed by an enterprise mobility management (EMM) provider that facilitates administration of client devices of an enterprise that are enrolled with the EMM provider. To this end, the operating system and application ecosystem associated with the managed device can provide various APIs and services that allow client devices to be enrolled as managed devices with the management service 121. The management service 121 can initiate installation of applications as managed applications. The management service 121 can also initiate installation of configuration profiles that can be accessed by certain applications installed on a presenter server device 105 or presenter managed device.

The management service 121 can include a management console that can allow administrators to manage devices that are enrolled with the management service 121. User interfaces can allow an administrator to define policies for a user account or devices associated with an enterprise environment. The user interfaces can also include, for example, presentations of statistics or other information regarding the devices that can be managed by the management service 121.

The data stored in the data store 112 associated with the management service 121 can include a directory 123, device records 131, user data 133, compliance rules 135, and potentially other data. The directory 123 can include the various objects and data structures that are associated with an enterprise directory. Objects within the directory 123 can be organized into data structures, such as forests, trees, domains, organizational units, groups, partitions, or other organizational structures depending upon the directory service 116. Additionally, the directory 123 can be replicated across more than one data store 112 for redundancy purposes. The inner-workings and specific structure of the directory 123 are not shown or discussed herein, as they are not necessary for an understanding of examples of this disclosure. The directory 123 can also be maintained by a directory service that is executed separately from the management service 121.

Within a directory 123, electronic records or objects corresponding to users 124 or user accounts can be created and stored. Data associated with the user 124 can also be stored in the directory 123 or in locations on a network specified by the directory 123. The data can include an email inbox, calendar data, documents or files, and other data stored by or associated with a particular user 124. In some examples, users 124 can be grouped into user groups by location, job function, or other grouping factors. Additionally, information about the devices assigned to user 124 can also be stored in the directory 123. For example, a user 124 can have a smartphone, a laptop or desktop computer, all of which can act as a presenter managed device or a presenter server device 105, or other devices that are assigned to the user and that are also enrolled with the management service 121 as managed devices.

Device records 131 can correspond to devices that are enrolled as managed devices with the management service 121. A device record 131 can include various security settings selected for enforcement on a managed device that is enrolled with the management service 121. Accordingly, a device record 131 can include a device identifier associated with a device, one or more device certificates, a compliance status 137, and other data. In some examples, a device record 131 can also identify a user associated with a particular device. The compliance status 137 can indicate whether a particular device is in compliance with one or more compliance rules 135.

More specifically, the device record 131 can include one or more of: data describing the identity, type and components of the device; data describing the state of the device; data describing organizational groups to which the device belongs; data describing compliance rules 135 with which the device must comply; data describing management policies that specify if, when, and how the device is permitted to function; and data describing a command queue associated with the device.

For example, data describing the identity, type and components of the managed device can specify at least one of more of: a unique identifier associated with the managed device (e.g., identifier issued by a manufacturer of the device or the management service 121), a device type of the device (e.g., a smartphone, a tablet computing, a laptop computer, a desktop computer, a server computer, or a virtualized instance of any of such computer types), and various software and hardware components of the managed device (e.g., operating system [or kernel or bios] type and version, processor type and speed, memory type and size, network interface types, various I/O component types such as camera, touchscreen, keyboard, mouse, printer). More particularly, a device record 131 associated with a managed device comprising a network connection television can specify that the managed device is a device type of phone, that the managed device has an active connection to the Internet, and that the managed device has a camera enabled.

Next, data describing the state of the managed device can specify, for instance, various settings that are applied to the managed device, various applications that are installed on or being executed by the managed device, and various files that are installed on or are accessible to the managed device. Additionally, the data describing the state of the managed device can specify information related to the management of the managed device, such as the last time the managed device provided its state information to the management service 121, whether the managed device is in a state of compliance with any applicable compliance rules 135, and whether any remedial actions have been (or are to be) taken as a result of a noncompliance with any applicable compliance rules 135. Also being related to the management of the managed device, the data describing organizational groups to which the managed device belongs can, for example, include any organizational groups of which the managed device is a member (by virtue of a static hard coded relationship between the managed device and an organizational group, or by virtue of a dynamic evaluation of a membership condition associated with an organizational group, as described later herein).

Further, the device record 131 can include data describing a command queue associated with the managed device. For example, the management service 121 can maintain a command queue of commands that are designated for execution against the managed device. As described herein, a managed device can be provisioned by the management service 121 by causing resources to be installed or stored on the managed device. To implement such process, the management service 121 can store a command related to provisioning in the command queue. Additionally, the management service 121 can store a command related to a remedial action associated with a compliance rule 135 in the command queue, in the event that it is determined that a rule condition associated with the compliance rule 125 has occurred. Whether a provisioning command or a command related to a remedial action is stored in the command queue, the managed device can retrieve commands stored in its command queue through various ways that are described later herein (e.g., through a client-server “pull system” or through a client-server “push system”).

Finally, data describing compliance rules 135 with which the managed device must comply can, for instance, specify one or more security policies to which the managed device must adhere, a compliance status 137 of the managed device, and one or more remedial actions that should be performed in the event that an associated rule condition occurs, as described later herein. In some embodiments, the data describing compliance rules 135 and the data describing management policies are obtained from an organizational record associated with an organizational group to which the managed device is a member (i.e., the compliance rules 135 associated with the organizational group are reflected in the device record of the member managed device).

A compliance status 137 of a managed device represents whether the device is in compliance with one or more compliance rules 135. Various compliance rules 135 can be enforced on the managed device by the management service 121. Compliance rules 135 can be based on time, geographical location, or device and network properties. For instance, the managed device can satisfy a compliance rule 135 when the managed device is located within a particular geographic location. The managed device can satisfy a compliance rule 135 in other examples when the managed device is in communication with a particular local area network, such as a particular local area network that is managed by the computing environment 203. Furthermore, a compliance rule 135 in another example can be based upon the time and date matching specified values.

A compliance rule 135 can specify that a managed device is required to be powered off or be in a low power “sleep” state during a specified time period. Another compliance rule 135 can specify that a managed device is required to be powered on or be in a normal operation “awake” state during a specified time period. As another example, a compliance rule 135 can specify that a managed device is prohibited from rendering content that has been designated as confidential. A compliance rule 135 can also specify whether a camera associated with the managed device must be enabled or disabled. The compliance rule 135 can also specify certain times of the day, week, or year in which certain hardware or software features are permitted to be enabled or disabled.

Another example of a compliance rule 135 involves whether a user belongs to a particular user group. For instance, a compliance rule 135 can include a whitelist or a blacklist that specifies whether particular users or groups of users are authorized to perform various functionalities, such as installing or executing a particular application.

Other examples of compliance rules 135 include a rule that specifies whether a managed device is compromised or “jailbroken.” For example, a managed device can have hardware or software protections in place that prevent unauthorized modifications of the managed device. If these protections are overridden or bypassed, the managed device can be considered out of compliance. As another example, a compliance rule 135 can specify that the managed device is required to authenticate a user using a password or personal identification number (PIN) in order to unlock the managed device.

A compliance rule 135 can also require that the managed device has device encryption enabled, where data stored on the device is stored in an encrypted form. The data can be encrypted by a device certificate. A compliance rule 135 can also require that the managed device be enrolled with the management service 121 as a managed device. Another compliance rule 135 can specify that the user is required to accept the terms of service that are presented by the management component 145 on the managed device. As another example, a compliance rule 135 can specify that the management component 145 is required to periodically communicate or “check-in” with the management service 121 to report on its status. If a threshold amount of time has elapsed since the previous check-in of the managed device, the managed device can be considered to have violated this compliance rule 135.

Another compliance rule 135 can specify that a managed device run one of a specified variant or version of a particular operating system. A compliance rule 135 can also specify that an enrolled device be manufactured by a particular manufacturer or have a particular manufacturer identifier. Another compliance rule 135 can specify that an enrolled device be a particular model name or model number. A managed device can also be considered out of compliance if the device is in a data roaming mode or has used a threshold amount of a periodic network data usage allowance.

A compliance rule 135 can also identify a list of required applications that must be installed on the managed device or a list of forbidden applications that cannot be installed on the managed device. The management component 145 can remove a forbidden application or install a missing required application on the managed device in response to detecting a violation of such a compliance rule 135. A compliance rule 135 can also require the presence of a mobile device management (MDM) profile, an MDM storage area, an application profile, and/or a configuration profile. The management component 145 can obtain and store missing required data or containers on the managed device in response to detecting a violation of such a compliance rule 135.

Therefore, the compliance status 137 indicates whether and to what extent a particular managed device is compliant with compliance rules 135 assigned to the managed device by the management service 121. The compliance status 137 can be determined by a management component 145 on the managed device that analyzes the status of the managed device and reports compliance to the management service 121. In other examples, the compliance status 137 can be determined by the management service 121 based upon state information describing the managed device, which can be reported by the management component 145. The compliance status 137 can also include the state of various hardware or software features of the managed device without respect to whether the status of the features are determined by a compliance rule 135.

Should a managed device be out of compliance with one or more compliance rules 135, the presenter server application 149 may disallow a presenter client device 106 from presenting content on the display device 107.

User data 133 contains information about users who are associated with client devices 106 that are enrolled with the management service 121. User data 133 can include profile information about a user, authentication information about a user, applications that are installed on client devices 106 associated with the user, and other user information. For example, user data 133 can include information about client devices 106 that are associated with a user account of the user, enterprise resources to which a particular user has access, such as email, calendar data, documents, media, applications, network sites, or other resources that can be accessed by a presenter client device 106 or presenter server device 105. The user data 133 can also identify one or more user groups of which a particular user is a member, which can in turn define the access rights of the user to one or more enterprise resources as well as identify which applications should be deployed to a managed device associated with the user. To this end, the user data 133 can further identify one or more device identifiers that can uniquely identify client devices 106 that are associated with a user account of the user. In some implementations, some of the user data 133 can be stored by or in locations specified by a directory service rather than in the data store 112 associated with the management service 121.

A presenter client device 106 and presenter server device 105 can represent managed or unmanaged devices that are coupled to the network 119. The devices include, for example, a processor-based computer system. According to various examples, a device can be in the form of a desktop computer, a laptop computer, a personal digital assistant, a mobile phone, a smartphone, or a tablet computer system. The device can represent a device that is owned or issued by the enterprise to a user, or a device that is owned by the user. The device, when managed, can be enrolled with the management service 121 as a managed device of the enterprise. In some implementations, the device can be an unmanaged device that is not enrolled with a management service 121.

In one implementation, a presenter client device 106 or presenter server device 105 can execute a management component 145 that can communicate with the management service 121 to facilitate management of the managed device. The management component 145 can communicate with the management service 121 to enforce management policies and compliance rules on the managed device. For example, the management component 145 can enforce data security requirements, install, remove or update security certificates, or write, modify or delete certain data from the managed device. The management component 145 can also monitor the managed device, generate state information describing the managed device, and provide the management service 121 with such state information. For example, the state information can include the network activity of the managed device, the location of the managed device, whether enforce password or personal identification number (PIN) authentication is enforced, and/or whether other compliance rules 135 are being complied with by the managed device. In one example, the state information can be generated by the management component 145 by receiving compliance rules 135 from the management service 121 over the network 119, comparing the state of the managed device to the compliance rules 135, and determining whether the managed device fails to satisfy the compliance rules 135.

To carry out local management of a managed device, the management component 145 can be installed and executed with elevated or administrative privileges on the managed device. In some scenarios, the operating system of the managed device can allow a particular application or package to be identified as a device owner or a device administrator, which can in turn configure the managed device using such privileges.

The presenter server device 105 can also execute a presenter server application 149. The presenter server application 149 can broker requests to present content from one or more presenter client devices 106 and allow a moderator to select content from one or more presenter client devices 106 for display on the display device 107. In some implementations, the presenter server application 149 can also automatically select content from a particular presenter client device 106 based upon a voice command from a user or by recognizing a voice match or voice print of a currently speaking user, which can be mapped to the user's presenter client device 106.

The presenter client device 106 can also execute a presenter client application 151. The presenter client application 151 can allow users to create content within a user interface of the application, which can be shared with the presenter server application 149 in a presenter session. The presenter client application 151 can provide white-boarding, note-taking, sketching, or other content creation tools that allow users to create content that can be presented on the display device 107 by way of the presenter server application 149. The presenter client application 151 can allow users to join a presenter session associated with the presenter server application 149 and request that the contents of the presenter client application 151 on their respective presenter client device 106 be shown on the display device 107. A session moderator can select which of the contents from multiple presenter client applications 151 should be displayed on the client device 107. The session moderator can be a human or an automatic moderator feature of the presenter server application 149. The presenter client device 106 can be a tablet, laptop or other personal computer, smartphone, digital whiteboard, or other device that allows users to interact with the device and create or view content. In some scenarios, the presenter server device 105 can also execute the presenter client application 151 and act as a presenter client in the presenter session.

A display device 107 can include a display device to which the presenter server device 105 can be connected. Although depicted as a wired connection, the connection between the presenter server device 105 and the display device 107 can be wired or wireless. The connection between the display device 107 and the presenter server device 105 allows the presenter server application 149 to output content for display. In some implementations, the display device 107 can be attached to the presenter server device 105 as a second display such that the content on an integrated display of the presenter server device 105 is different from the content shown on the display device 107. The display device 107 can be connected to the presenter server device 105 using an HDMI connection, a wireless display protocol, or a proprietary protocol such as APPLE AIRPLAY, GOOGLE CAST, or other protocols that allow the presenter server device 105 to output content for display on the display device 107.

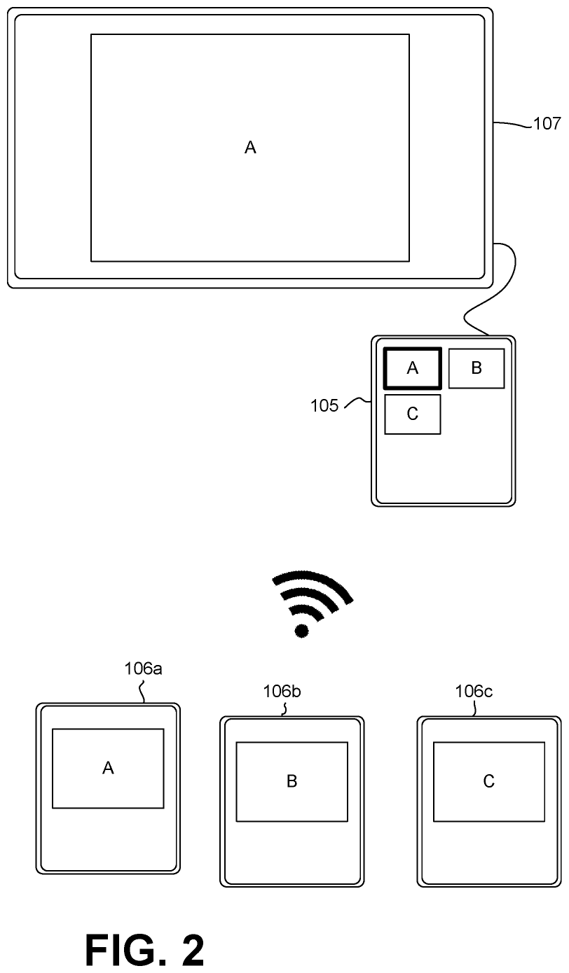

Referring next to FIG. 2, shown is a scenario that illustrates the functioning of the presenter server application 149 and presenter client application 151 according to examples of the disclosure. As shown in FIG. 2, the presenter server application 149, executing on a presenter server device 105, can be connected to the display device 107. The display device 107 can be a projection system or display in an enterprise setting, for example. In FIG. 2, three presenter client devices 106a, 106b, and 106b, have joined a presenter session created by the presenter server application 149. The presenter server application 149, in one example, can create a presenter session and broadcast a message to other presenter client applications 106 that are on a common network, enterprise account, domain, or other categorization of which users in the session can be members. In one example, the psa 149 can allow a moderator to send an invitation to users through a cloud-based conferencing service to join a presenter session created by the moderator, which the users can access through a link. When followed by a user on a presenter server device 105, the link can cause the presenter client application 151 to be launched on the device and the presenter client application 151 to join the presenter session created by the presenter server application 149 on the presenter server device 105.

A request to join a presenter session from a presenter client application 151 can also be accompanied by a device identifier of the presenter client device 106. In some examples, the presenter server application 149, before allowing the presenter client application 151 to join a particular presenter session, can verify that the presenter client device 106 is in compliance with one or more compliance rules 135 that are enforced by the management service 121 and/or management component 145. Should a device be out of compliance with a particular compliance rule 135, the presenter server application 149 can refuse entry into the presenter session.

Users on the various presenter client devices 106 can create content within the respective presenter client application 151 executed on the device. The different content created using the presenter client application 151 are denoted by the letter A, B, and C. The presenter client application 151 can allow the users of the presenter client devices 106 to transmit their respective content to the presenter server application 149 when completed or as a real time video stream. In some examples, rather than transmitting contents of the presenter client application 151 directly to the presenter server application 149, the contents can be sent to a cloud-based conferencing or presentation service that the presenter server application 149 can also access.

The presenter server application 149 can render a user interface that allows moderator to view the contents of the various presenter client devices 106 that are members of the presenter session. The contents of the presenter client devices 106 that are members of the presenter session can be shown in a tiled, cascading, or mosaic user interface where a preview or smaller view of the contents are shown. In some examples, the presenter server application 149 user interface can also include an indication that the contents of a presenter client application 151 in the presenter session is ready for its contents to be shown on the display device 107. In this scenario, a user of the presenter client application 151 can indicate using the presenter client application 151 that the content created on that presenter client device 106 are ready for presentation.

In the scenario shown in FIG. 2, the moderator of the presenter session has selected the content from presenter client device 106a for display on the display device 107. Accordingly, the presenter server application 149 can cause content A to be shown on the display device 107. The presenter server application 149 can also highlight or otherwise identify content A in the user interface on the presenter server device 105 that content A is currently being shown on the display device 107. Additionally, the presenter server application 149 can also allow the moderator of the presenter session to enlarge content A on the integrated display of the presenter server device 105 and edit, mark up, or provide comments to content A. The edited content can also be provided to the presenter client application 151 executed on the presenter client device 106a or saved to either device or a cloud-based storage.

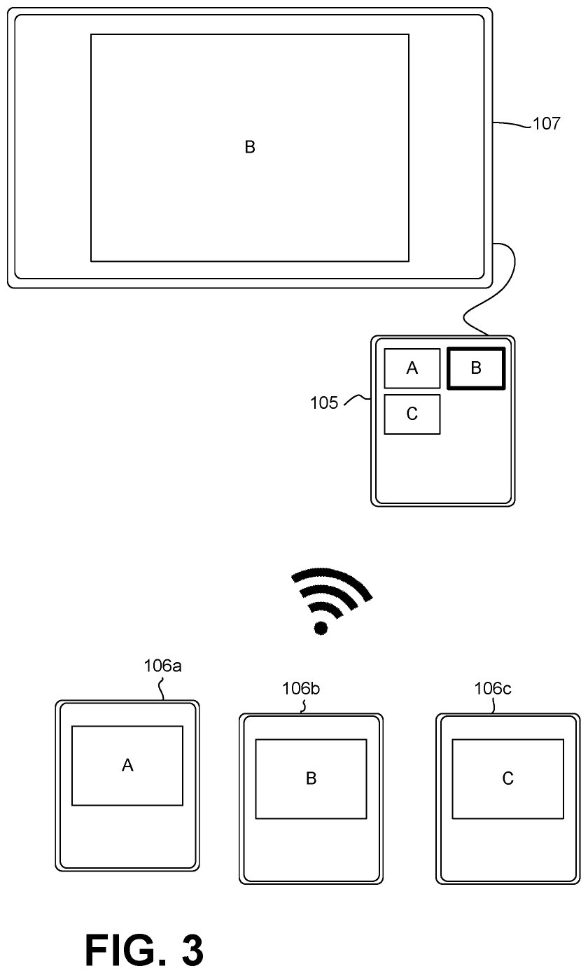

Continuing the scenario shown in FIG. 2, reference is now made to FIG. 3. Again in FIG. 3, the presenter server application 149, executing on a presenter server device 105, can be connected to the display device 107. The three presenter client devices 106a, 106b, and 106b remain joined to a presenter session created by the presenter server application 149. FIG. 3 illustrates how the presenter server application 149 can receive a selection of different content from the presenter session, content B, which is then shown on the display device 107. The moderator, using the user interfaces generated by the presenter server application 149, can select from various content from the presenter client devices 106 that are members of the presenter session. In this way, moderating a group that has broken into various breakout groups is streamlined.

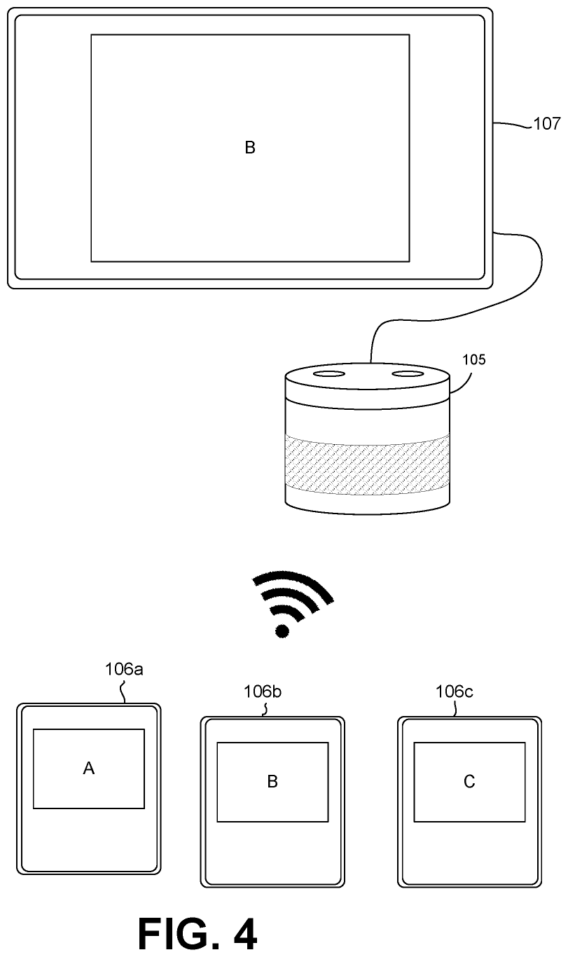

Referring next to FIG. 4, shown is an alternative scenario involving a presenter session according to embodiments of the disclosure. As shown in FIG. 4, the presenter server device 105 is a voice assistant without a display device. In this scenario, the moderation of the content shown on the display device 107 can be automated. Automated moderation of the content can also be performed by a presenter server device 105 that has a display device and that could be equipped with a microphone system. For example, the device shown in FIGS. 2-3 can perform automated moderation if equipped or connected to a microphone. The voice assistant device illustrated in FIG. 4 is only an example.

Returning to FIG. 4, the presenter server application 149 can be running on the voice assistance device or in a cloud-based voice assistant ecosystem with which the device is communicating. The presenter server application 149 in the depicted scenario can perform automated moderation of the content shown on the display device 107 by identifying a voice print, voice match, or perform voice recognition to identify a currently speaking user. The presenter server application 149 can then identify which of the presenter client devices 106 corresponds to the speaking user and display the content associated with that user. To implement automated moderation in this way, the directory 123 or other repository can store a voice fingerprint of a user population. Before or upon joining a presenter session, the user can identify himself by authenticating his identity. For example, to join the presenter session, a conferencing or presentation service can require that the user authenticate with a single-sign on portal or with the service itself, which can be linked to the user's identity in the directory 123 and a stored voice fingerprint.

Accordingly, the voice assistant device can detect the user's voice and automatically display the content from the instance of the presenter client application 151 executed by the user's device on the display device 107. In one example, the presenter server application 149 can only switch content shown on the display device 107 after the user has been detected to be speaking for a minimum threshold amount of time. This can avoid switching of content too often. In another implementation, the presenter server application 149 can switch content on the display device 107 in response to a keyword and a subsequent explicit command to switch the content shown. For example, the presenter server application 149 can await a moderator's instruction to show and subsequently change the content shown on the display device 107. As another example, the presenter server application 149 can await a spoken keyword or command and identify the speaker based on the voice fingerprint of the user to automatically switch to the content associated with the detected user's device.

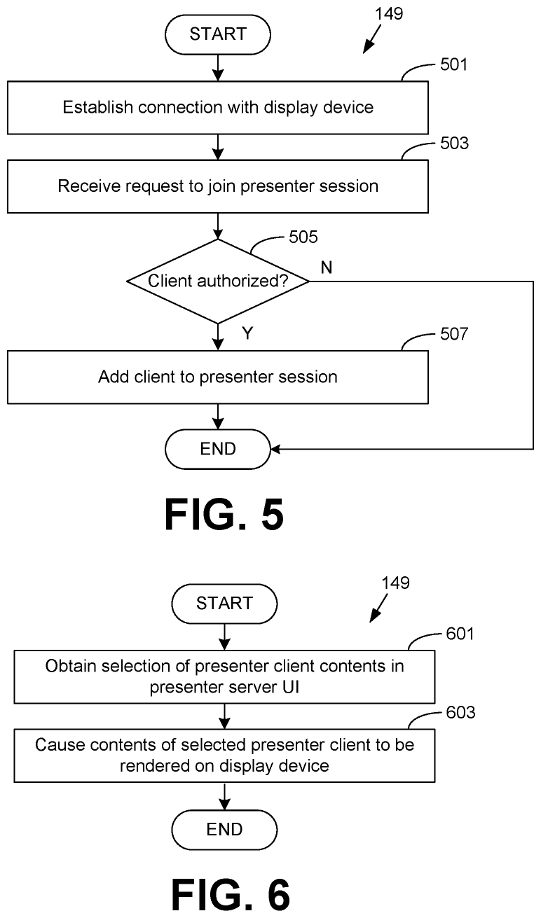

Referring to FIG. 5, shown is a flowchart that provides one example of how the presenter server application 149 can initiate a presenter session and render the contents of a presenter client application 151 on a display device 107.

First, at step 501, the presenter server application 149 can establish a connection with a display device 107. As noted above, the connection with the display device 107 permits the presenter server application 149 to select from among the various content submitted by presenter client devices 106 that have joined the presenter session. The connection to the display device 107 can be a wired or wireless connection.

At step 503, the presenter server application 149 can receive a request to join a presenter session. The presenter server application 149, in one example, can create a presenter session and broadcast a message to other presenter client devices 106 that are on a common network, enterprise account, domain, or other categorization of which users in the session can be members. In one example, the presenter server application 149 can allow a moderator to send an invitation to users through a cloud-based conferencing service to join a presenter session created by the moderator, which the users can access through a link. When followed by a user on a presenter server device 105, the link can cause the presenter client application 151 to be launched on the device and the presenter client application 151 to join the presenter session created by the presenter server application 149 on the presenter server device 105.

At step 505, the presenter server application 149 can determine whether the presenter client application 151 requesting access to the presenter session is authorized to join the session. In one scenario, the moderator can establish a password for the presenter session that the presenter server application 149 can validate. In another scenario, the presenter server application 149 can verify compliance of the requesting presenter client device 106 with one or more compliance rules 137 by sending a request to the management service 121 with the device identifier of the presenter client device 106. If the presenter server application 149 determines that the requesting presenter client device 106 is not authorized to access the presenter session, the process proceeds to completion, as the presenter server application 149 can deny access to the presenter session. If the presenter server application 149 determines that the presenter client device 106 it authorized to enter the presenter session, the process can proceed to step 507.

At step 507, the presenter server application 149 can add the presenter client device 106 to the presenter session. Upon adding the presenter client device 106 to the presenter session, the presenter server application 149 can await the contents of the presenter client application 151 executing on the presenter client device 106 to provide content to display on the display device 107. Thereafter, the process can proceed to completion.

Referring to FIG. 6, shown is a flowchart that provides one example of how the presenter server application 149 can display content from a presenter client application 151 on a display device 107.

First, at step 601, the presenter server application 149 can obtain a selection of contents shown in a user interface of the presenter server application 149. The user interface can display the contents of the various presenter client application 151 instances that correspond to members of the presenter session. In the case of an automated moderation, the presenter server application 149 can obtain audio from a microphone can determine whether the audio matches a voice fingerprint that in turn corresponds to user on a presenter client application 151 that is joined to the presenter session.

At step 603, the presenter server application 149 can cause the contents of the selected presenter client application 151 to be displayed on the display device. Again, the connection between the display device 107 and the presenter server device 105 allows the presenter server application 149 to output content for display. In some implementations, the display device 107 can be attached to the presenter server device 105 as a second display such that the content on an integrated display of the presenter server device 105 is different from the content shown on the display device 107. The display device 107 can be connected to the presenter server device 105 using an HDMI connection, a wireless display protocol, or a proprietary protocol such as APPLE AIRPLAY, GOOGLE CAST, or other protocols that allow the presenter server device 105 to output content for display on the display device 107. Thereafter, the process can proceed to completion.

The flowcharts of FIGS. 4-5 show examples of the functionality and operation herein can be embodied in hardware, software, or a combination of hardware and software. If embodied in software, each element can represent a module of code or a portion of code that includes program instructions to implement the specified logical function(s). The program instructions can be embodied in the form of source code that includes human-readable statements written in a programming language or machine code that includes machine instructions recognizable by a suitable execution system, such as a processor in a computer system or other system. If embodied in hardware, each element can represent a circuit or a number of interconnected circuits that implement the specified logical function(s).

Although the flowcharts of FIGS. 4-5 show a specific order of execution, it is understood that the order of execution can differ from that which is shown. The order of execution of two or more elements can be switched relative to the order shown. Also, two or more elements shown in succession can be executed concurrently or with partial concurrence. Further, in some examples, one or more of the elements shown in the flowcharts can be skipped or omitted. In addition, any number of counters, state variables, warning semaphores, or messages could be added to the logical flow described herein, for purposes of enhanced utility, accounting, performance measurement, or troubleshooting aid. It is understood that all such variations are within the scope of the present disclosure.

The managed device, computing environment 103, or other components described herein, can each include at least one processing circuit. The processing circuit can include one or more processors and one or more storage devices that are coupled to a local interface. The local interface can include a data bus with an accompanying address/control bus or any other suitable bus structure. The one or more storage devices for a processing circuit can store data or components that are executable by the one or processors of the processing circuit. Also, a data store can be stored in the one or more storage devices.

The management service 121, client application 149, and other components described herein can be embodied in the form of hardware, as software components that are executable by hardware, or as a combination of software and hardware. If embodied as hardware, the components described herein can be implemented as a circuit or state machine that employs any suitable hardware technology. The hardware technology can include one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

Also, one or more or more of the components described herein that includes software or program instructions can be embodied in any non-transitory computer-readable medium for use by or in connection with an instruction execution system such as a processor in a computer system or other system. The computer-readable medium can contain, store, or maintain the software or program instructions for use by or in connection with the instruction execution system.

The computer-readable medium can include physical media, such as, magnetic, optical, semiconductor, or other suitable media. Examples of a suitable computer-readable media include, but are not limited to, solid-state drives, magnetic drives, flash memory. Further, any logic or component described herein can be implemented and structured in a variety of ways. One or more components described can be implemented as modules or components of a single application. Further, one or more components described herein can be executed in one computing device or by using multiple computing devices.

It is emphasized that the above-described examples of the present disclosure are merely examples of implementations to set forth for a clear understanding of the principles of the disclosure. Many variations and modifications can be made to the above-described examples without departing substantially from the spirit and principles of the disclosure. All of these modifications and variations are intended to be included herein within the scope of this disclosure.

1. A method, comprising:
establishing, by a presenter server application, a connection between a presenter device and a display device, the display device being separate from a display of the presenter device;
receiving, from a plurality of presenter client applications corresponding to a plurality of client devices, a request to join a presenter session established by the presenter server application;
causing, by the presenter server application, contents of the plurality of presenter client applications that are shared with the presenter server application to be displayed by the presenter server application on the display of the presenter device;
obtaining, by a user interface of the presenter server application, a selection of a first one of the contents of a first one of the client devices; and
causing, by the presenter server application, the selection to be rendered on the display device, wherein the contents of the plurality of presenter applications remain displayed on the display of the presenter device.

2. The computer-implemented method of claim 1, further comprising:
obtaining, by the presenter server application, a second selection of a second one of the contents; and
causing, by the presenter server application, the second selection to be rendered on the display device.

3. The computer-implemented method of claim 1, wherein the plurality of presenter client applications are executed by a respective plurality of digital whiteboard devices.

4. The computer-implemented method of claim 1, wherein the selection of the first one of the contents is obtained through touchscreen user interface on the presenter device.

5. The computer-implemented method of claim 1, wherein the selection of the first one of the contents is obtained by identifying a voice corresponding a first one of the presenter client applications, the voice obtained through a microphone associated with the presenter server device.

6. The computer-implemented method of claim 1, further comprising authenticating, by the presenter server application, that a presenter client device corresponding to the contents is in compliance with at least one compliance rule by querying a management service with a device identifier obtained from the presenter client application.

7. The computer-implemented method of claim 1, wherein the presenter server device also executes a presenter client application that is one of the plurality of presenter client applications.

8. A system, comprising:
a computing device; and
a presenter server application executed by the computing device, the presenter server application causing the computing device to at least:
establish a connection between a presenter device and a display device, the display device being separate from a display of the presenter device;
receive a request to join a presenter session established by the presenter server application from a plurality of presenter client applications corresponding to a plurality of client devices;
cause contents of the plurality of presenter client applications that are shared with the presenter server application to be displayed by the presenter server application on the display of the presenter device;
obtain a selection of a first one of the contents of a first one of the client devices; and
cause the selection to be rendered on the display device, wherein the contents of the plurality of presenter applications remain displayed on the display of the presenter device.

9. The system of claim 8, wherein the presenter server application causes the computing device to at least:
obtain a second selection of a second one of the contents; and
cause the second selection to be rendered on the display device.

10. The system of claim 8, wherein the plurality of presenter client applications are executed by a respective plurality of digital whiteboard devices.

11. The system of claim 8, wherein the selection of the first one of the contents is obtained through touchscreen user interface on the presenter device.

12. The system of claim 8, wherein the selection of the first one of the contents is obtained by identifying a voice corresponding a first one of the presenter client applications, the voice obtained through a microphone associated with the presenter server device.

13. The system of claim 8, wherein the presenter server application causes the computing device to at least authenticate that a presenter client device corresponding to the contents is in compliance with at least one compliance rule by querying a management service with a device identifier obtained from the preserver client application.

14. The system of claim 8, wherein the computing device also executes a presenter client application that is one of the plurality of presenter client applications.

15. A non-transitory computer-readable medium embodying code executable by a presenter server device, the code causing the presenter server device to at least:
establish a connection between a presenter device and a display device, the display device being separate from a display of the presenter device;
receive a request to join a presenter session established by the presenter server application from a plurality of presenter client applications corresponding to a plurality of client devices;
cause contents of the plurality of presenter client applications that are shared with the presenter server application to be displayed by the presenter server application on the display of the presenter device;
obtain a selection of a first one of the contents of a first one of the client devices; and
cause the selection to be rendered on the display device, wherein the contents of the plurality of presenter applications remain displayed on the display of the presenter device.

16. The non-transitory computer readable medium of claim 15, wherein the code further causes the presenter server device to at least:
obtain a second selection of a second one of the contents; and
cause the second selection to be rendered on the display device.

17. The non-transitory computer readable medium of claim 15, wherein the plurality of presenter client applications are executed by a respective plurality of digital whiteboard devices

18. The non-transitory computer readable medium of claim 15, wherein the selection of the first one of the contents is obtained through touchscreen user interface on the presenter device.

19. The non-transitory computer readable medium of claim 15, wherein the presenter server application causes the computing device to at least authenticate that a presenter client device corresponding to the contents is in compliance with at least one compliance rule by querying a management service with a device identifier obtained from the preserver client application.

20. The non-transitory computer readable medium of claim 15, wherein the selection of the first one of the contents is obtained by identifying a voice corresponding a first one of the presenter client applications, the voice obtained through a microphone associated with the presenter server device.
